(19) United States
(12) Patent Application Publication
(10) Pub. No.: US 2008/0091717 A1
(43) Pub. Date: Apr. 17, 2008

(54) Generation of Collaborative Playlist Based Upon Musical Preference Data from Multiple Digital Media Players

(76) Inventors: Zachary Adam Garbow, Rochester, MN (US); Bryan Mark Logan, Rochester, MN (US); Terrence Theodore Nixa, Rochester, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/535,652

(22) Filed: Sep. 27, 2006

(51) Int. Cl. G06F 17/00

(52) U.S. Cl. 707/104.1

(57) ABSTRACT

An apparatus, program product, and method collect musical preference data from a plurality of digital media players and generate therefrom a “collaborative” playlist of media files. The collaborative playlist may be used, for example, to identify and play back media files that most, if not all, of the users of the digital media players would likely find enjoyable.

### FIELD OF THE INVENTION

The invention relates to computers and computer software, and in particular, to the generation of playlists of media files stored on digital media players.

### BACKGROUND OF THE INVENTION

The popularity of entertainment content such as music, videos, movies, television programs, and the like has soared as new technologies for obtaining and playing back the content have been developed. One significant development in this area has been the introduction of digital media. In the area of music, musical works or songs are now commonly available in an encoded and compressed format such as MP3 media files. Furthermore, a number of competing formats, e.g., WMA, AAC, Vorbis, etc., have been developed, some providing lossy or lossless compression and/or the ability to copy-protect the digital content. Playback of such files is often performed by a general purpose computer or other electronic device, both of which are referred to herein collectively as “digital media players” (DMP's).

Media files were originally playable only on general purpose computers due to storage and processing requirements. Specialized software, referred to herein as digital media player software, but also commonly referred to as digital jukebox software, has been developed to assist in the storage, organization and play back of media files stored on a general purpose computer. In addition, some digital media player software includes an interface to an online music store from which music can be downloaded and/or purchased from the Internet.

Most digital media playback software applications permit users to store identification information about different songs, e.g., title, album, artist, composer, lyrics, album artwork, musical genre, tempo, mood, release date, etc., as well as permit users to rate individual songs. In addition, many such applications enable users to create “playlists,” or groups of songs having one or more shared characteristics. Consequently, rather than listening to all of the songs on a particular album in order as was common when music was released on vinyl records, cassette tapes or CD's, users of digital media player software may be able to create complex playlists such as “all up tempo rock songs with a rating above 3 stars and released between 1960 and 1967.” Some applications also enable users to create “smart” playlists that are dynamically updated as new songs are added to a user's library.

While the early focus of digital media playback was on general purpose computers, advances in computer technology have enabled a wide array of consumer electronic devices to incorporate functionality to store and play back digital media files. Chief among these devices in terms of popularity has been the standalone portable digital media player (commonly referred to as an “MP3 player”), which is typically hard disk or flash memory based, and which is often in a small enough form factor as to be conveniently carried around by a user. Standalone portable DMP's are extremely popular with students, commuters, runners, and others who have a desire to listen to music when they are on the go. Typically, standalone DMP's are capable of connecting to digital media player software on a general purpose computer and downloading media files, as well as playlists, from the general purpose computer.

Standalone portable DMP's often include headphones to enable a user to listen to their digital media content privately. However, a growing market has arisen around the concept of “docking” a standalone portable DMP to another electronic device to enable the content on the DMP to be played on the other device. Home or portable docks have been developed with powered speakers, for example, as have docks for audio/video receivers used in many home entertainment systems. In addition, docks have been developed to enable users to playback content from a DMP over a car stereo. As a result of these developments, listening to the content of a DMP no longer needs to be a solitary experience—users can now share their content with others in the car, at parties and in other social gatherings.

One limitation with docking a standalone portable DMP to another device is that there is generally a 1:1 ratio of DMP's to docking devices. Consequently, if there are a group of people at any given location, only one individual's DMP can be used at a time to play music, which leads to a situation where all of the music played is from one person's personal preferences. Some docking devices, e.g., for use as DJ machines, enable two standalone portable DMP's to be docked at a time; however, the songs on each DMP are still accessed through the individual user interface of each DMP.

Many users go to great lengths to create playlists with songs that he or she feels that others in a social situation may like, e.g., playlists for party mixes, or playlists for road trips. However, even when a user attempts to take into account the listening preferences of others in the creation of playlists, the playlists are still based principally upon that user's listening preferences, and more importantly, based entirely on the songs that are on that user's DMP.

Therefore, there is a need for a method of facilitating the playback of media files such as songs and other musical works to groups of individuals in a manner that better reflects the listening preferences of those individuals.

### SUMMARY OF THE INVENTION

The invention addresses these and other problems associated with the prior art by providing an apparatus, program product, and method capable of collecting musical preference data from a plurality of digital media players and generating therefrom a “collaborative” playlist of media files. The collaborative playlist may be used, for example, to identify and play back media files that most, if not all, of the users of the digital media players would likely find enjoyable. Such a playlist is collaborative to the extent that the playlist typically reflects the musical preferences of the owners or users of the digital media players from which the musical preference data has been collected. As such, a greater likelihood exists that media files from the collaborative playlist, when played back to the users of the digital media players, whether individually or as a group, will be positively received by those users.

Consistent with one aspect of the invention, a collaborative playlist of media files is generated by receiving musical preference data from each of a plurality of digital media players, where the musical preference data for each digital media player identifies media files resident on such digital media player, and generating a collaborative playlist including a plurality of media files selected based upon the musical preference data received from at least a subset of the plurality of digital media players.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of the principal hardware components in a system suitable for generating a collaborative playlist in a master playback device based upon musical preference data collected from a plurality of digital media players in a manner consistent with the invention.

FIG. 2 is a flowchart illustrating the program flow of a routine executed by the components in the system of FIG. 1 to collect musical preference data from a plurality of digital media players, generate a collaborative playlist, and distribute the collaborative playlist to the digital media players.

FIG. 3 is a flowchart illustrating the program flow of a generate collaborative playlist routine executed by the routine of FIG. 2.

FIG. 4 is a flowchart illustrating the program flow of a routine executed by the components in the system of FIG. 1 to enable users of digital media players to request the purchase of a song identified in a collaborative playlist.

FIG. 5 is a flowchart illustrating the program flow of a routine executed by the components in the system of FIG. 1 to purchase songs from a collaborative playlist.

### DETAILED DESCRIPTION

The embodiments discussed hereinafter are capable of generating “collaborative” playlists based upon musical preference data collected from multiple digital media players (DMP's). The musical preference data, in the least, identifies some or all of the audio or media files resident on an associated DMP, and may include various types of identifying information associated with such audio or media files, e.g., title, filename, artist, composer, performer, tempo, mood, genre, album, lyrics, comments, format, time, play count, last time played, release date, added date, or any other type of information that may be associated with an audio or media file (e.g., including but not limited to any type of information that may be stored as metadata such as in an ID3 tag). Furthermore, musical preference data may include other information that may indicate a user's particular like or dislike of a particular song or genre of songs, e.g., a playback history such as a list of recently played media files, one or more stored playlists, a personal rating representing that user's personal like or dislike of various songs, etc. As discussed in greater detail below, information such as a playback history may also be used for a second purpose of excluding from a collaborative playlist media files to which a particular user may have recently listened.

The musical preference data associated with multiple DMP's may be used in a number of manners in connection with generating a collaborative playlist. For example, different types of information may be used or excluded, and different types of information may be weighted to emphasize or de-emphasize such information in the selection of media files for inclusion in a collaborative playlist. Furthermore, the commonality of musical preference data among multiple DMP's may be used to identify those media files that potentially have the greatest appeal to the majority of users of the DMP's. For example, if four DMP's are connected to a host or master device, and three DMP's have 20 rock songs each, with the fourth having 20 rock songs and 500 country songs, the commonality of the rock songs among all of the DMP's would suggest that rock songs should be emphasized or weighted over country songs, despite the fact that only 14% (80/580) of the songs that are potentially available for inclusion in a collaborative playlist are rock songs.

In one exemplary embodiment discussed hereinafter, a master or host device is used to build a collaborative list of songs and play back songs from the collaborative list such that the songs may be heard by users of DMP's proximate to the master or host device. In this regard, the audio or media files stored on the DMP's are typically for musical works or songs, or, if video is also incorporated into such files, music videos. It will be appreciated, however, that the invention is not specifically limited to use in the playback of audio or media files for musical works or songs, as collaborative playlists may be generated for audio or media files that store audible content other than for musical works or songs. The use of the term “song” to describe the content of audio or media files therefore should not be limited to include only a musical work or performance.

In the exemplary embodiment, a master or host device is networked with multiple DMP's via a wireless network such as wireless Ethernet or Bluetooth, so that DMP's may interface with the master or host device whenever they are proximate to the master device. In other embodiments, a wired connection may be utilized. A standard wireless communication protocol may be utilized to allow DMP's to automatically connect with a master or host device when placed in proximity therewith, and if desired, authentication may be used to prevent rogue or unwanted devices from introducing junk playlists or spam songs.

In such an embodiment, once a DMP is connected to a master device, the master device requests a list of songs from that DMP. The list of songs may include all songs on the DMP, or alternatively, a subset of the songs, e.g., as identified on one or more playlists, as limited by a particular attribute (e.g., genre, artist, etc.), or even just the songs for which complete song information (e.g., artist, title, album, genre, etc) is available. Users may be permitted to limit the songs made available for sharing, e.g., by putting songs in a particular shared playlist. By doing so, a master device may analyze playlists individually in order to merge similar playlists rather than entire libraries of songs. This potentially allows a master device system to more intelligently create appealing groupings of songs, and also provides a way for users to more selectively choose the type of shared music they wish to listen to at a particular time via the appropriate playlist. A user's individual playlist could also be used to present their current taste. For example, if a user has a large variety of music on their DMP that they are not in the mood to listen to, they can select a playlist and only those songs will be shared with the master device. This is also helpful if the user is required by a significant other to store songs that he or she doesn't particularly enjoy on the DMP.

Once lists of songs are uploaded from one or more connected DMP's, the master device then weighs the songs from all connected DMP's using an algorithm that typically takes into account the number of DMP's on which a particular song, genre, and/or artist appears. In general, the more DMP's upon which a particular song, genre, artist, etc. is found, the higher that song, genre or artist will be ranked or scored for the purpose of potential inclusion in a collaborative playlist. If a particular criteria isn't met (for example, if the country music genre only appears on one device out of five connected DMP's), then that criteria may be considered less eligble, or possibly completely ineligble, for inclusion in a collaborative playlist. A generation algorithm may also utilize other information, e.g., the acoustical “DNA” of songs, in the selection of suitable songs. A generation algorithm may also look at the makeup of songs on individual DMP's, e.g., to attempt to match the overall distribution of songs of different types. For example, a playlist on a DMP may be composed of 60% rock and 30% pop and 10% slow pop, whereby it may be desirable to factor this distribution of genres into the overall distribution of songs in the collaborative playlist.

It will be appreciated that a collaborative playlist generation algorithm may also include personal rating information input by users of the DMP's, reflecting the users' personal opinions, likes or dislikes of certain songs, artists, genres, etc. However, typically a collaborative playlist generation algorithm will also rely on information other than user ratings, e.g., identification data and/or the commonality of identification data regarding specific songs, artists, genres, etc. resident in the various DMP's.

Generation of a collaborative playlist may result in the generation of a static list of songs, e.g., limited to a specific number of songs, limited to a specific combined duration of time, etc. In this regard, various selection algorithms, e.g., random selection or round robin selection, may be used to limit the number of songs incorporated into a collaborative playlist when the number of songs suitable for inclusion in a playlist exceeds the desired amount. It will also be appreciated that a collaborative playlist may be dynamic in nature, such that songs are added or removed to or from a collaborative playlist as DMP's connect or disconnect to or from the master devices and/or as songs are added or removed to or from any DMP. Furthermore, the manner in which songs are ordered in a collaborative playlist may vary in different embodiments, e.g., based upon random ordering and/or based upon weight (so that songs that are ranked or scored higher by the generation algorithm will be played before lower ranked songs). It will also be appreciated that when a media file is included in a collaborative playlist, typically only an identifier for the media file need be incorporated into the collaborative playlist itself so that the media file can later be accessed.

In addition, in the exemplary embodiment, after generating a collaborative playlist, the master device may begin playback of songs from the collaborative playlist. In some embodiments, a song may only be selected for inclusion in a playlist if the song is already resident on the master device or otherwise downloadable by the master device from another source (e.g., via an online music store). In other embodiments, however, a master device may be permitted to upload the actual audio or media files from individual DMP's, either in digital (e.g., via the wireless connection) or analog (e.g., via an FM transmitter) format. In this regard, the master device may also cache songs from a collaborative playlist in advance by requesting the upload of songs from one or more DMP's.

Audio or media files may be uploaded in compressed or uncompressed format, and in copy-protected or non-copy-protected format, which may require decoding or decryption to be performed either in the DMP or in the master device. Audio or media files may also be re-encrypted and/or recompressed by a DMP to comply with format requirements of the master device. In one embodiment, audio or media files may be uploaded in a raw (uncompressed and unencrypted) format such as a WAV format, which would provide the advantage of not requiring the master device to support the native format of a DMP or to have the necessary keys for decrypting encrypted files stored on the DMP's. To comply with copy-protection requirements, DMP's may be provided with an encryption key by the master device to prevent audio or media files from being communicated “in the clear” to the master device, with the master device specifically licensed by copyright holders to have limited rights to playback copy-protected songs stored on the DMP's (e.g., where a master device is only permitted to cache songs from a DMP when that DMP is connected to the master device, and then delete the songs when the DMP is no longer connected).

In addition, a handshake protocol may be established to enable the master device and DMP to determine the formats respectively supported by each device, so that a suitable format supported by both devices may be used. A master device master may also act as a DMP, and in this regard, if the master device has it's own local collection of music, it may generate a collaborative playlist based upon its content as well as that of the other DMP's connected thereto. A master device may also be configurable to constrain the types of music that will be incorporated into a collaborative playlist. For example, if a master device is being used to generate a collaborative playlist at a dance club, it may be desirable to add only songs appropriate for such an environment, and exclude non-appropriate music such as classical or folk music.

Also in the exemplary embodiment, it may be desirable to enable DMP's to obtain the list of songs, or at least the currently playing song, from a collaborative playlist. A user may then use their own DMP interface to perform various actions associated with the collaborative playlist. For example, a user could look ahead in a collaborative playlist and select particular songs he or she wishes to hear, or alternatively, songs that he or she does not wish to hear. The generated feedback may then be provided to the master device to dynamically alter the collaborative playlist, e.g., by moving songs ahead or back in the playlist, or by combining the feedback with feedback from other users to alter the ordering of songs in the playlist. The feedback may also be used to note that a user likes or dislikes particular songs, artists, genres, etc. Furthermore, the feedback need not be limited to feedback on songs stored on a particular user's DMP.

It may also be desirable to permit a user to select a song, artist, album, etc. from a collaborative playlist for download and/or purchase via the DMP interface, or to later obtain additional information. The download may be directly through the DMP, through the master device, or through another host computer, e.g., the user computer with which the DMP is synchronized.

It is also typically desirable to upload playback histories from the DMP's to the master device in connection with generating a collaborative playlist. By doing so, the master device may omit songs to which a particular user has recently listened. Furthermore, it may be desirable to update the playback histories of individual DMP's based upon the play back of songs from a collaborative playlist, such that the users will not hear the same songs repeated when the DMP's are no longer connected to the master device. The playback history in a DMP may even be updated to reflect the playback of songs that are not stored on that DMP, such that if the DMP ever connects to the same or a different master device, the user will not hear the same songs again.

Among other applications, the exemplary embodiment may be used to enable a master device to play songs that match the collective listening preferences of the users in the vicinity of the master device, using the musical preference data wirelessly uploaded from each DMP to the master device. For example, a master device could be used at a party or gathering, e.g., implemented within a desktop computer or an audio/video receiver, to enable a playlist to be created from the songs stored on the DMP's of the partygoers. As another example, a car stereo may be used as a master device to create a collaborative playlist for a road trip using the songs from the DMP's of the occupants of a vehicle.

As another potential application, a night club, bar or other public place may be able to build collaborative playlists that meet the preferences of its patrons. In such a situation, it may be desirable to upload only musical preference data, rather than media files themselves, to preclude any “spoof” attacks and avoid any legal issues related to public performance. The patron's data may simply be used to determine what a DJ or automated system plays from the club's library of licensed music.

Other modifications and variations will be apparent to one of ordinary skill in the art having the benefit of the instant disclosure.

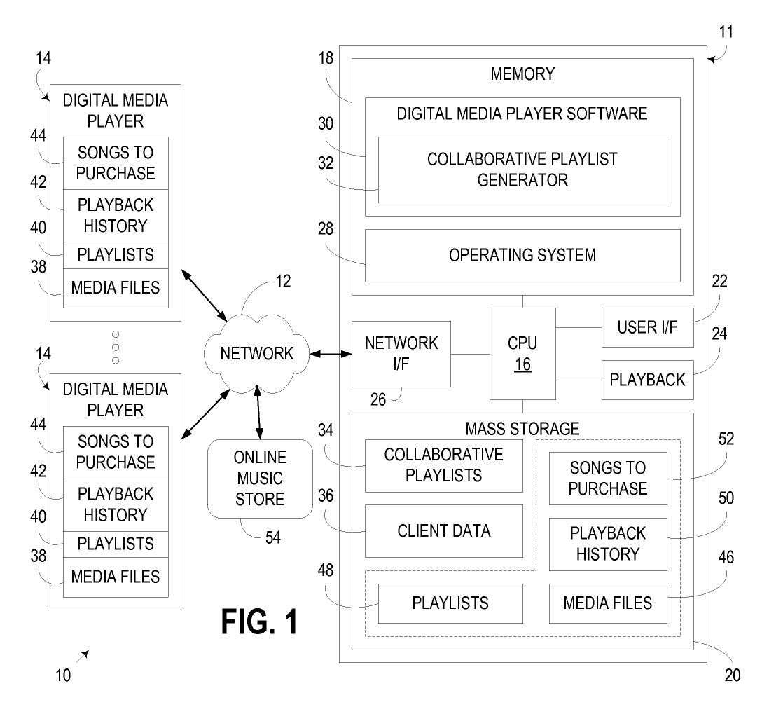

Turning now to the Drawings, wherein like numbers denote like parts throughout the several views, FIG. 1 illustrates a system 10 within which collaborative playlist generation consistent with the invention may be implemented. System 10 in the illustrated embodiment includes a master device or apparatus 11 implemented as a general purpose computer, or alternatively a dedicated audio playback device such as a jukebox, audio receiver, car stereo, home or mobile entertainment device, DJ device or the like. Any programmable electronic device capable of collecting musical preference data from digital media players, generating a playlist therefrom, and optionally playing back songs from such a playlist may be used in the alternative.

Master device 11 is coupled via a network 12 to a plurality of digital media players (DMP's) 14, which may be implemented, for example, as standalone portable digital media players such as MP3 players, mobile phones, PDA's, or any other portable electronic devices capable of storing media files and information regarding the same. In the alternative, one or more of DMP's 14 may be implemented as a general purpose computer having suitable digital media player software, e.g. a desktop computer, a laptop computer, a programmable electronic device, or the like.

As such, for the purposes of the invention, each device 11, 14 may represent practically any type of computer, computer system or other programmable electronic device, and may even be implemented using one or more networked computers or devices, e.g., in a cluster or other distributed computing system.

Master device 11 typically includes a central processing unit 16 including at least one microprocessor coupled to a memory 18, which may represent the random access memory (RAM) devices comprising the main storage of device 11, as well as any supplemental levels of memory, e.g., cache memories, non-volatile or backup memories (e.g., programmable or flash memories), read-only memories, etc. In addition, memory 18 may be considered to include memory storage physically located elsewhere in device 11, e.g., any cache memory in a processor in CPU 16, as well as any storage capacity used as a virtual memory, e.g., as stored on a mass storage device 20 or on another device coupled to device 11. Device 11 also typically receives a number of inputs and outputs for communicating information externally. For interface with a user or operator, device 11 typically includes a user interface 22 incorporating one or more user input devices (e.g., a keyboard, a mouse, a game controller, a trackball, a joystick, a touchpad, and/or a microphone, among others) and a display (e.g., a CRT monitor, an LCD display panel, and/or a speaker, among others). Otherwise, user input may be received via another computer or terminal.

Device 11 also optionally functions as a playback device, and includes a playback circuit 24, which may be used to output an audio signal for the purpose of playing back songs identified in a collaborative playlist. The playback circuit 24 may simply output a digital or analog audio signal in compressed or uncompressed format for playback locally or remotely by another electronic component, or in the alternative, may include DAC circuitry, amplifiers and/or speakers to enable the audio signal to be audibilized.

For additional storage, device 11 may also include one or more mass storage devices 20, e.g., a floppy or other removable disk drive, a hard disk drive, a direct access storage device (DASD), an optical drive (e.g., a CD drive, a DVD drive, etc.), and/or a tape drive, among others. Furthermore, device 11 may include an interface 26 with one or more networks 12 (e.g., a LAN, a WAN, a wireless network, and/or the Internet, among others) to permit the communication of information with other computers and electronic devices. It should be appreciated that device 11 typically includes suitable analog and/or digital interfaces between CPU 16 and each of components 18, 20, 22, 24 and 26 as is well known in the art. Other hardware environments are contemplated within the context of the invention.

Device 11 operates under the control of an operating system 28 and executes or otherwise relies upon various computer software applications, components, programs, objects, modules, data structures, etc., e.g., a digital media player software 30 incorporating a collaborative playlist generator 32. Moreover, various applications, components, programs, objects, modules, etc. may also execute on one or more processors in another device coupled to device 11 via network 12, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code”, or simply “program code”. Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to tangible, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

To implement collaborative playlist generation consistent with the invention, device 11 includes program code that implements a collaborative playlist generator 32, which in the illustrated embodiment is incorporated within digital media player software 30, e.g., a digital jukebox or other software-based media player. Generator 32 is used to generate one or more collaborative playlists 34 based upon musical preference data, also referred to herein as client data 36, which has been collected from the DMP's 14.

The client data 36 may include a number of types of information resident on each DMP 14. For example, the client data may include identification data associated with some or all of the media files 38 resident on each DMP. In addition, the client data may include one or more playlists 40 resident on each DMP, as well as playback history information 42 (e.g., a recently played list) representative of the frequency that particular songs have been played by the owner or user of a DMP. In addition, for the purpose of facilitating the purchase of songs by individual users, the client data may also include a list of songs to purchase 44, which is maintained on each DMP as a list of songs that the user has decided that he or she would like to download and purchase.

Device 11 may be implemented as a heterogeneous type of device from DMP's 14, e.g., as a jukebox or DJ device that merely plays audio or media files stored on the DMP's. In the alternative, however, device 11 may also include DMP functionality, and as such, may itself include local audio or media files 46 as well as local playlists 48, a local playback history 50 and a local list of songs to purchase 52. In some embodiments, for example, device 11 may be the same type of device as DMP's 14, whereby the device 11 and DMP's 14 operate more like interconnected peers. As such, while device 11 is referred to herein as a master device, it will be appreciated that device 11 may operate in a “master” or “server” capacity only to the extent that the device collects musical preference data and generates a collaborative playlist. It will also be appreciated that any device that generates a collaborative playlist need not be the same device that plays back media files from the generated collaborative playlist.

It will also be appreciated that the media or audio files herein may be encoded into any number of formats, e.g., MP3, WAV, WMA, AAC, Vorbis, and other lossy or lossless, compressed or uncompressed, audio formats known in the art. A media or audio file may include only audio information, or may also include other information, e.g., metadata such as ID3 tags, as well as video information, text information, etc. In one exemplary application, for example, media files may be music video files that include video along with the audio for a song. In another exemplary application, media files may be karaoke files that include animation and/or lyrics for a song.

In the illustrated implementation of FIG. 1, various functions associated with collecting musical preference data, generating collaborative playlists and distributing playlists and media files in association therewith are described as being implemented in particular components in system 10. In other embodiments, however, the various functions may be implemented in different components, so the invention is not limited to the particular partitioning of functionality between various components as described herein in connection with the illustrated embodiments.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

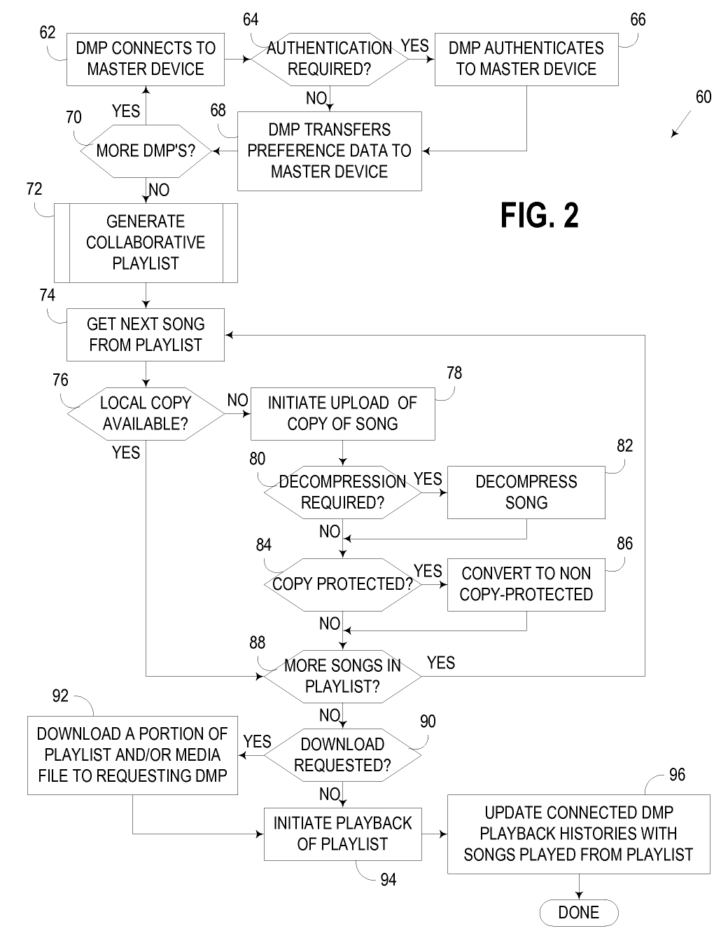

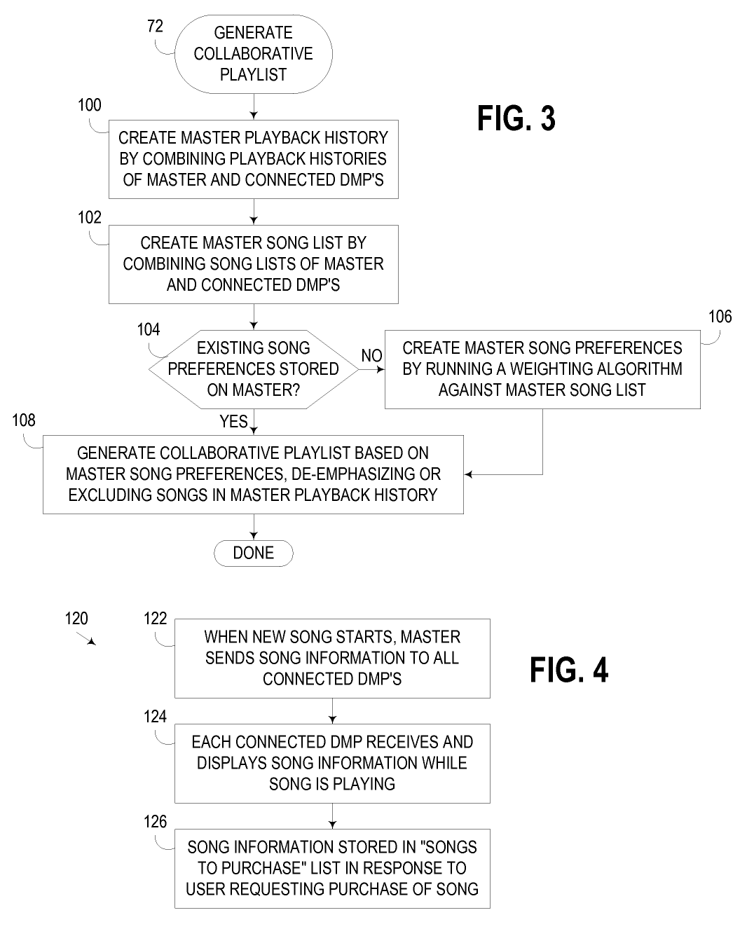

FIGS. 2-3 next illustrate routines implemented in system 10 for implementing collaborative playlist generation consistent with the invention. FIG. 2, for example, illustrates a routine 60 suitable for collecting musical preference data from a plurality of DMP's, generating a collaborative playlist, and distributing information from the collaborative playlist to the DMP's. Routine 60 begins in block 62 where a DMP connects to the master device, e.g., via a wireless protocol. Block 64 then determines whether authentication is required, and if it is, passes control to block 66, where the DMP authenticates to the master device. Authentication can be implemented via any number of known protocols, e.g., username/password, key, etc.

Once the DMP is authenticated, or if authentication is not required, control passes to block 68, where the DMP transfers its relevant musical preference data to the master device. As noted above, the musical preference data can include identification data, rating data, and other preference data associated with all or a subset of the audio or media files on the DMP (e.g., only audio or media files placed in a shared playlist on the DMP by the user). In addition, additional information that may be used to ascertain the user's musical likes and/or dislikes, e.g., playlists and a playback history, may also be uploaded to the master device from the DMP. Control then passes to block 70 to determine whether any more DMP's are awaiting connection to the master device. If so, control passes to block 62 to connect another DMP.

If, however, all DMP's are connected, a generate collaborative playlist routine 72 is called to generate one or more collaborative playlists based upon the musical preference data uploaded from the connected DMP's. Once such a playlist has been generated, control then passes to block 74 to initiate playback of songs from the collaborative playlist.

Specifically, block 74 selects a next song from the collaborative playlist, e.g., by selecting the first unplayed song in the playlist, or selecting a song randomly. Block 76 then determines whether the master device has a local copy of the media file for the song stored therein. If not, control passes to block 78 to initiate an upload of a copy of the media file for the song from one of the DMP's that has a copy thereof. Alternatively, the master device could download the media file from an online music store or other external source (e.g., online music store 54 of FIG. 1).

Next, block 80 determines whether decompression/decoding of the media file associated with the song is required, and if so, control passes to block 82 to decompress the relevant media file. If no decompression is required, or after decompression is complete, control passes to block 84 to determine whether the media file is copy protected. If so, control passes to block 86 to decrypt the media file or otherwise convert the media file to a non-copy-protected format. If the file is not copy-protected, or after decryption is complete, control passes to block 88 to determine whether any more songs remain to be processed in the playlist. If so, control returns to block 74 to process additional songs. Furthermore, returning to block 76, if a local copy is already available on the master device control passes directly to block 88, bypassing blocks 78-86.

In alternate embodiments of the invention, the upload of media files may be performed on an as-needed basis, e.g., so that the master device always has one or more songs cached in advance so that playback of a cached song can be initiated immediately upon completion of an earlier song. Furthermore, it will be appreciated that blocks 80-86 may be performed by a DMP, by the master device, or by a combination of a DMP and the master device, depending upon the format with which the media file is transmitted to the master device.

Returning to block 88, once all songs in the playlist have been uploaded as needed, control passes to block 90 to optionally determine whether any download has been requested by one of the DMP's. If so control passes to block 92 to download all or a portion of the collaborative playlist and/or one or more of the media files for the songs in the collaborative playlist. After this download is complete, or if no download is requested, control passes to block 94 to initiate the playback of songs from the collaborative playlist. Then, as shown in block 96, as songs are played back by the master device, the playback histories of the connected DMP's are updated to reflect that the user has recently listened to such songs. Playback of songs from the collaborative playlist continues until playback is terminated, either manually by a user of the master device, or automatically if all songs have been played and no repeat option has been selected by a user of the master device. Routine 60 is then complete.

FIG. 3 illustrates one exemplary implementation of generate collaborative playlist routine 72. The routine begins in block 100 by creating a master playback history by combining the playback histories of all of the connected DMP's, and if it exists, with that stored on the master device. Block 102 then creates a master song list by combining the song lists of the connected DMP's, and if songs are stored locally on the master device, the song list of the master device.

Next, block 104 determines whether any existing song preferences are stored on the master device, i.e., whether a generation algorithm has already been run on the master device to create rankings or scores for songs on the master song list. If not, control passes to block 106 to create master song preferences by running a weighting algorithm against the master song list.

If the master song preferences already exist, or after the preferences are created, control passes to block 108 to generate the collaborative playlist based on the master song preferences. In this process, songs that are in the master playback history are either excluded or de-emphasized to minimize the likelihood that any user hears a song that he or she has recently listened to. Once the playlist has been generated, routine 72 is complete, and control returns to routine 60.

It will be appreciated that the weighting algorithm performed in block 106 may be implemented using any number of algorithms suitable for ranking or scoring songs based upon the likes and/or dislikes of the users of the DMP's from which the master list of songs and the musical preference data was culled. Furthermore, fuzzy logic or neural network based algorithms may be used to improve the prediction of what songs best match user listening preferences. In general, for any song, the more commonality among DMP's with respect to the presence of the song, the presence of songs by the same artist, the presence of songs in the same genre, etc., the higher the rank that will be assigned to the song. Furthermore, with respect to any song, the more that any user shows an affinity for that song, or for the artist or genre associated with that song, the higher the rank that will be assigned to the song. The implementation of a suitable algorithm for weighting such factors and ranking or scoring songs for inclusion or exclusion from a collaborative playlist would be well within the abilities of one of ordinary skill in the art having the benefit of the instant disclosure.

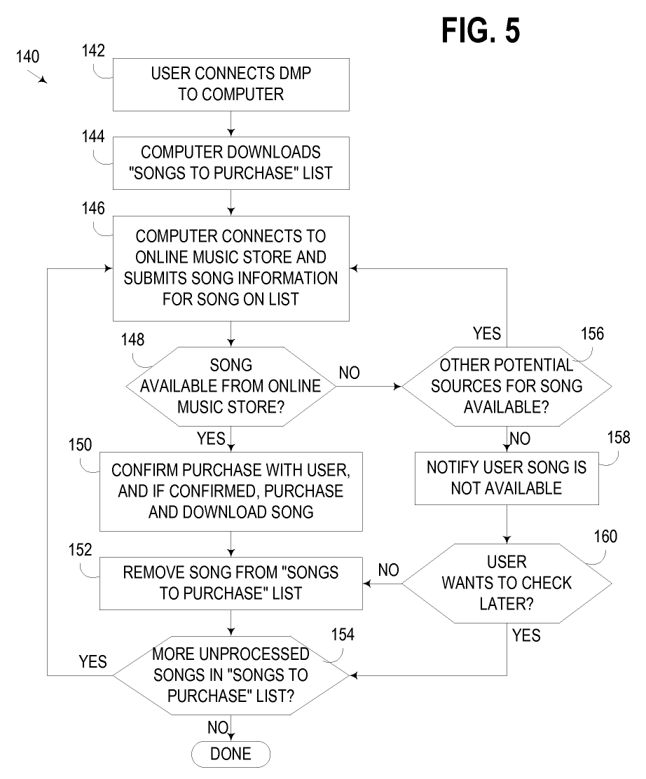

FIGS. 4-5 next illustrate an additional function optionally supported in system 10, that of enabling the download and/or purchase of songs from a collaborative playlist. Specifically, routine 120 of FIG. 4 enables users of connected DMP's to request the purchase of a song identified in a collaborative playlist. Routine 120 begins in block 122, where upon the beginning of playback of a song from the collaborative playlist, the master device communicates information about the song to all connected DMP's. Next, in block 124 each connected DMP receives and displays the relevant song information, thus alerting each user of the DMP's in the vicinity of the master device as to the song, and optionally other information such as artist, title, genre, etc. Next, in block 126, if any given user wishes to download or purchase the song while it is playing, the user can request such download or purchase, e.g., through selection of a button or menu item via the user interface for the DMP. An identifier for the song is then stored in a “songs to purchase” list 44 (FIG. 1).

FIG. 5 next illustrates a routine 140 suitable for performing the actual purchase of songs from a collaborative playlist after a user of a DMP has requested such purchase in the manner described above in connection with FIG. 4. Routine 140 begins in block 142, where a user connects the DMP to a computer, e.g., the computer with which the user normally synchronizes and backs up the contents of the DMP. During synchronization, the computer downloads the “songs to purchase” list from the DMP in block 144. The computer then connects to an online music store (e.g., online music store 54 of FIG. 1) and submits the relevant song information for a song from the list.

Next, block 148 determines whether the song is available from the online music store. If so, control passes to block 150 where the purchase is confirmed with the user, and the song is downloaded and purchased, typically using any number of protocols common to conventional commercial music download services. Block 152 then removes the song from the “songs to purchase” list for the DMP, and control passes to block 154 to determine whether any more unprocessed songs remain on the “songs to purchase” list.

If so, control returns to block 146 to process an additional song from the list. Otherwise, routine 140 is complete.

Returning to block 148, if a particular song is not available from the online music store, control passes to block 156 to determine whether any other potential sources for the song are available. Given that different online music stores typically have different songs in their respective catalogs, it is possible that a song may be available from another source. Accordingly, if another potential source exists, block 156 passes control to block 146 to attempt to download the song from the other source.

If, however, block 156 determines that no other sources exist for the song, control passes to block 158 to notify the user that the song is not available. The user is then given the option in block 160 of being able to check to see if the song is available at a later time. If the user does not wish to check the song later, control passes to block 152 to remove the song from the “songs to purchase” list. Otherwise, control passes to block 154 to process other songs, while leaving the unpurchased song on the list.

Various modifications may be made to the illustrated embodiments without departing from the sprit and scope of the invention. For example, rather than building a collaborative playlist once based upon a static set of connected DMP's, a collaborative playlist and/or the underlying ranking or scoring of songs used in the selection of songs for inclusion on such a playlist may be generated dynamically and/or incrementally, e.g., based upon the connection and/or disconnection of individual DMP's to or from the master device. As such, a collaborative playlist may adapt over time as new DMP's connect to the master device and/or old DMP's disconnect from the master device.

In addition, it will be appreciated that DMP's need not remain connected to a master device at all times. In some instances, no further communication between a master device and a DMP may be required once musical preference data has been uploaded by the DMP.

Furthermore, it will be appreciated that while the routines discussed above reference certain operations performed by specific components and in a specific sequence, it will be appreciated that some functions may be performed interchangeably by DMP's and the master device in different embodiments. In addition, different functions may be performed in parallel in some embodiments, e.g., where songs are uploaded to the master device in parallel with the playback of earlier songs in the collaborative playlist.

Various additional modifications to the herein-described embodiments will be apparent to one of ordinary skill in the art having the benefit of the instant disclosure. Therefore, the invention lies in the claims hereinafter appended.

What is claimed is:

1. A method of generating a collaborative playlist of media files, the method comprising:
receiving musical preference data from each of a plurality of digital media players, wherein the musical preference data for each digital media player identifies media files resident on such digital media player; and
generating a collaborative playlist including a plurality of media files selected based upon the musical preference data received from at least a subset of the plurality of digital media players.

2. The method of claim 1, wherein generating the collaborative playlist includes including a first media file among the plurality of media files based upon the musical preference data received from at least two of the plurality of digital media players.

3. The method of claim 1, further comprising playing media files identified in the collaborative playlist in a playback device that is separate from the plurality of digital media players.

4. The method of claim 3, wherein a first media file identified in the collaborative playlist is resident on the playback device prior to receiving the musical preference data.

5. The method of claim 3, wherein a first media file identified in the collaborative playlist is resident on a first digital media player among the plurality of digital media players, the method further comprising uploading the first media file from the first audio player to the playback device.

6. The method of claim 5, wherein uploading the first media file includes uploading the entire first media file into the playback device prior to initiating playback of the first media file.

7. The method of claim 5, wherein the first media file is stored in a compressed format on the first digital media player, wherein uploading the first media file includes decompressing the first media file and transmitting the first media file to the playback device in an uncompressed format.

8. The method of claim 5, wherein the first media file is stored in a copy protected format on the first digital media player, wherein uploading the first media file includes converting the first media file to a non-copy protected format and transmitting the first media file to the playback device in the non-copy protected format.

9. The method of claim 3, further comprising updating a recently played list on a first digital media player among the plurality of digital media players to identify any media files played from the collaborative playlist by the playback device.

10. The method of claim 1, wherein the musical preference data received from a first digital media player among the plurality of digital media players includes identification data associated with at least a subset of media files stored on the first digital media player.

11. The method of claim 10, wherein the musical preference data received from the first digital media player includes identification data associated with every media file stored on the first digital media player.

12. The method of claim 10, wherein the musical preference data received from the first digital media player includes identification data associated with a plurality of media files identified in a playlist stored on the first digital media player.

13. The method of claim 10, wherein the identification data includes data selected from the group consisting of title, filename, artist, composer, performer, tempo, mood, genre, album, lyrics, comments, format, time, play count, last time played, release date, added date, and combinations thereof.

14. The method of claim 10, wherein the musical preference data received from the first digital media player includes rating data representing how well a user of the first digital media player personally likes or dislikes various media files stored on the first digital media player.

15. The method of claim 10, wherein generating the collaborative playlist includes weighting identification data associated with a subset of media files and selecting media files for inclusion in the collaborative playlist based upon the weighted identification data.

16. The method of claim 10, wherein generating the collaborative playlist includes identifying identification data that is common to multiple digital media players and selecting media files for inclusion in the collaborative playlist based upon common identification data.

17. The method of claim 1, further comprising downloading at least a portion of the collaborative playlist to a first digital media player among the plurality of digital media players.

18. The method of claim 17, wherein receiving the musical preference data includes receiving a user selection of an media file identified in the collaborative playlist from the first digital media player.

19. The method of claim 17, further comprising enabling the first digital media player to download at least one media file identified in the collaborative playlist subsequent to downloading the portion of the collaborative playlist to the first digital media player.

20. The method of claim 1, wherein the musical preference data received from a first digital media player among the plurality of digital media players includes a list of recently played media files, and wherein generating the collaborative playlist includes excluding at least one media file identified in the list of recently played media files.

21. The method of claim 1, wherein receiving the musical preference data is performed by a master device disposed proximate to and coupled wirelessly to the plurality of digital media players.

22. The method of claim 21, further comprising authenticating a first digital media player among the plurality of digital media players with the master device prior to receiving musical preference data from the first digital media player.

23. The method of claim 1, wherein the plurality of digital media players are standalone portable digital media players.

24. An apparatus, comprising:
a communications interface configured to interface with a plurality of digital media players; and
control logic coupled to the communications interface and configured to receive musical preference data from each of the plurality of digital media players and generate a collaborative playlist including a plurality of media files selected based upon the musical preference data received from at least a subset of the plurality of digital media players, wherein the musical preference data for each digital media player identifies media files resident on such digital media player.

25. The apparatus of claim 24, further comprising playback logic coupled to the control logic and configured to play back media files identified in the collaborative playlist.

26. An apparatus, comprising:
a plurality of digital media players; and
a master device in communication with the plurality of digital media players and configured to receive musical preference data from each of the plurality of digital media players and generate a collaborative playlist including a plurality of media files selected based upon the musical preference data received from at least a subset of the plurality of digital media players, wherein the musical preference data for each digital media player identifies media files resident on such digital media player.

27. A program product, comprising:
program code configured to communicate with a plurality of digital media players, receive musical preference data from each of the plurality of digital media players and generate a collaborative playlist including a plurality of media files selected based upon the musical preference data received from at least a subset of the plurality of digital media players, wherein the musical preference data for each digital media player identifies media files resident on such digital media player; and
a computer readable medium bearing the program code.
